(19) United States
(12) Patent Application Publication
(10) Pub. No.: US 2025/0256946 A1
(43) Pub. Date: Aug. 14, 2025

(54) AUTONOMOUS RESTRICTION NAVIGATION

(71) Applicant: Schlumberger Technology Corporation, Sugar Land, TX (US)

(72) Inventors: Scott DiPasquale, Sugar Land, TX (US); Zhandos Ombayev, Sugar Land, TX (US)

(21) Appl. No.: 19/047,941

(22) Filed: Feb. 7, 2025

Related U.S. Application Data
(60) Provisional application No. 63/551,616, filed on Feb. 9, 2024.

(51) Int. Cl. B66D 1/48; B66D 1/24

(52) U.S. Cl. CPC B66D 1/485; B66D 1/24

(57) ABSTRACT

A method for autonomous restriction navigation comprising the steps of: 1) defining one or more restriction specifications in a digital execution program; 2) inputting the digital execution program into a core algorithm; 3) comparing a current depth of a toolstring against the one or more restriction specifications; 4) predicting a future action of the toolstring; 5) determining one or more appropriate gears based on the future action of the toolstring; and 6) comparing the one or more appropriate gears with another one or more appropriate gears to determine an output.

### CROSS-REFERENCE TO RELATED APPLICATIONS

The present application claims priority to U.S. Provisional Application 63,551,616 dated Feb. 9, 2024, the entirety of which is incorporated by reference.

### FIELD OF THE DISCLOSURE

Aspects of the disclosure relate to wireline and slickline operations. More specifically, aspects of the disclosure relate to autonomous restriction navigation of components used in wireline and slickline operations.

### BACKGROUND

Restriction navigation during wireline and slickline operations presents numerous challenges. In such operations, the conveyance speed of the toolstring must be controlled. In typical operations, the speed of operations is reduced to allow for accurate monitoring and positioning. The slower conveyance speeds can prevent safety events such as cable pile-up or cable pull-off. The slower conveyance speeds also allow sufficient reaction time for operators if the toolstring gets caught up on a restriction that may be present within the wellbore.

During conventional manual operation, operators must pay constant attention to toolstring depth while driving the winch. While paying attention to the toolstring depth, the depth of restrictions present in the well must be reviewed. Toolstring speed must be controlled during the operations in order to prevent operational problems. In many cases, the operators are challenged during these operations, which, in turn, introduces human error to the manual operations. Many instances are observed in field operations where speed is not reduced as the toolstring passes through a restriction but instead continues at the same speed the operator uses for nonrestricted parts of the well. This may cause binding and/or a stuck downhole toolstring, necessitating expensive fishing/removal operations. In other cases, the operator is too cautious, slowing the tool string down too much, causing inefficiencies in field performance. The operator will slow down to a desired restriction speed far in advance of the restriction, causing the toolstring to move at a slow speed. In instances where nonrestricted speed is high but restriction speed is low, this is a notable efficiency reduction. The operator may also delay accelerating the toolstring until it has moved significantly beyond the restriction, due to an excess of caution in assuring that the toolstring is past the restriction.

Automated operation, where the winch is driven by software instead of a human operator, has improved on some of the inefficiencies encountered in manual operation, most notably the behavior when encountering restrictions. Some gaps in the previous-generation automation system nevertheless remained. These gaps include not taking into account the toolstring length. These previous systems treat depth as a single point measurement somewhere on the toolstring (typically the bottom, but not always). Accordingly, the depth measurement could be outside a restriction while some or most of the toolstring was inside the restriction, leading to overspeeding. The previous generation systems were only reactive and would not act to slow down the toolstring until the measured depth was inside the restriction. Because mechanical systems have significant inertia, decelerating the toolstring to restriction speed takes some amount of time, meaning that the toolstring may enter the restriction at excessive speed and only slow down while in the restriction. To avoid these issues, the operator would need to manually define a set of “phantom” restrictions before and after the real physical restrictions, to attain proper speed when inside the real restriction.

Lastly, the winch typically possesses two or more gears, to be used at different winch speeds. The winch must be fully stopped to change gears. If restriction speed and unrestricted speed are sufficiently different, the automated system will stop the winch to change to a lower gear, then stop again to switch back to a higher gear after the restriction is exited. Experienced human operators; however, will retain the higher gear at low speed if the time spent at reduced speed is low. Thus, automated operation is not optimal and can be improved.

There is a need for a system to overcome the above mentioned deficiencies, to significantly increase efficiency and safety during wireline or slickline navigation.

There is a further need to provide an apparatus and methods that are easier to operate than conventional apparatus and methods.

There is a further need to provide apparatus and methods that do not have the drawbacks discussed above.

There is a still further need to reduce economic costs associated with operations and apparatus described above with conventional tools.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for autonomous restriction navigation of a toolstring in a downhole environment is disclosed. The method may comprise defining at least one restriction specification in a digital execution program. The method may also comprise inputting the digital execution program into a core algorithm. The method may also comprise comparing a current depth of the toolstring against the at least one restriction specification. The method may also comprise predicting a future action of the toolstring. The method may also comprise determining at least one appropriate gear based on the future action of the toolstring. The method may also comprise comparing the at least one appropriate gear with another one or more appropriate gears to determine an output.

In another example embodiment, a system for autonomous restriction navigation is disclosed. The system may comprise a processor and a memory accessible to the processor. The system may further comprise processor-executable instructions stored in the memory and executable by the processor to instruct the system to define one or more restriction specifications in a digital execution program. The instructions may also comprise inputting the digital execution program into a core algorithm. The instructions may also be configured to compare a current depth of a toolstring against the at least one restriction specification. The instructions may also be configured to predict a future action of the toolstring. The instructions may also be configured to determine one or more appropriate gears based on the future action of the toolstring and compare the one or more appropriate gears with another at least one appropriate gear to determine an output.

In another example embodiment, a method for autonomous restriction navigation of a toolstring in a downhole environment is disclosed. The method may comprise defining at least one restriction specification in a digital execution program. The method may further comprise inputting the digital execution program into a core algorithm. The method may further comprise comparing a current depth of the toolstring against the at least one restriction specification. The method may further comprise predicting a future action of the toolstring. The method may further comprise determining at least one appropriate gear based on the future action of the toolstring. The method may further comprise comparing the at least one appropriate gear with another at least one appropriate gear to determine an output. The method may further comprise operating a winch according to the output.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIG. 1 is an overview of a high-level automated system and data flow of the present invention, according to one or more examples of the disclosure.

FIG. 2 is an example of a user interface for specifying restrictions, according to one or more examples of the disclosure.

FIG. 3 is a flowchart depicting steps and data flow of a restriction navigation algorithm, according to one or more examples of the disclosure.

FIG. 4 is a wellbore depicting a restriction speed example, according to one or more examples of the disclosure.

FIG. 5 is a wellbore depicting another restriction speed example, according to one or more examples of the disclosure.

FIG. 6 is a wellbore depicting another restriction speed example, according to one or more examples of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer, or section. Terms such as “first”, “second”, and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on”, “engaged to”, “connected to”, or “coupled to” another element or layer, it may be directly on, engaged, connected, coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Restriction navigation during wireline and slickline operations presents numerous challenges, and while the introduction of conventional automated systems has improved on some of the inefficiencies encountered during manual operation, some gaps in these previous-generation automation system nevertheless remained.

Aspects of the disclosure aim to overcome these gaps, where the operator only gives a set of real physical restrictions to the automation system. The automation system uses a forward-looking algorithm to predict arrival time at the restrictions and slow down appropriately. The automation system utilizes the entire length of the toolstring when comparing toolstring depth to restriction depth. When possible, the current gear being used will be retained even if the speed is low.

The present automation system can be segmented into three techniques in order to overcome the gaps described above. These techniques include toolstring length awareness, restriction prediction, and gear change awareness.

### TOOLSTRING LENGTH AWARENESS

Embodiments of the disclosure provide for different aspects that provide for navigation of toolstrings. As part of the embodiments, a Digital Execution Plan (DEP) governs automated operation, the overall toolstring length is included, as well as where the ‘current depth’ measurement is situated along the toolstring. Using these values, at any given moment the current depth value can be converted into top-of-toolstring (TOTD) and bottom-of-toolstring (BOTD) depths allowing identification of position within a wellbore.

These values described above are used when exiting a restriction in order to guarantee that the toolstring does not accelerate back to normal speed until the entire toolstring is out of the restriction. Specifically:
When pulling out of hole (POOH), the toolstring will retain restriction speed until the BOTD is higher than the top of the restriction;
When running in hole (RIH), the toolstring will retain restriction speed until TOTD is deeper than the bottom of the restriction.

Additionally, toolstring length awareness is used when entering restrictions as described separately.

### RESTRICTION PREDICTION

The DEP contains a list of restrictions. Accordingly, the automation system can use current depth and direction of conveyance to find any restrictions that will occur in the future in the current direction. The speed of the toolstring is also available for use in calculations and display for an operator. The system's speed controller provides the acceleration and deceleration rates that the controller uses when managing conveyance speed. The information described above, combined with toolstring length, can be used to guarantee that the toolstring enters a restriction at a speed consistent with the restriction speed limit, as follows:
For a given direction and depth, the distance to the next restriction is found
   If direction is POOH, the distance is TOTD to bottom of the restriction; or
   If direction is RIH, the distance is BOTD to top of the restriction;
Using deceleration rate, current speed, and restriction speed, the distance required to slow to restriction speed is calculated;
Once the distance to a restriction is equal to or less than the deceleration distance, the speed controller is instructed to reduce speed to the restriction's speed limit;
The speed controller will then decelerate the toolstring to the restriction's speed limit; and
Because the deceleration began an appropriate distance before the restriction, the toolstring will enter the restriction at a speed equal to or slower than the restriction's speed limit.

### GEAR CHANGE AWARENESS

In hardware configurations with different gears, a gear may be changed to match a designated toolstring speed. In one embodiment, lower gears are used for lower speeds and higher gears for higher speeds. The toolstring is required to stop to effect gear changes. Without any special consideration, the acceleration and deceleration operations described in embodiments would therefore require the toolstring to stop moving in order to change gears. Experienced field operators do not do this for restrictions, instead choosing to remain in a higher gear through the restriction in order avoid time lost due to stopping and restarting the winch, even if the restriction's speed limit is lower than typically used for a higher gear.

In embodiments described herein, the automation system can do the same as described above in relation to the human counterpart. The aspects of the system also guarantee that a change to a lower gear does occur in situations where it should occur. It does this as follows:
The gear will change if the desired speed, either from the user or from the orchestration control system, corresponds to a different gear than the current gear.
The gear will change if approaching a low-speed restriction near the surface.
The gear will change if approaching a restriction whose speed is too low for stable control at a higher gear.
The gear will change if there is any reason for a slow speed or a specific gear other than a restriction. For example:
   If the hardware itself has imposed a speed limit; or
   If conditions such as depth mandate a specific gear
If none of the above conditions are in effect, and the reduction in speed is determined to be due to an upcoming or current restriction, the system will retain a higher gear through the restriction.

### OVERVIEW OF DATA FLOW

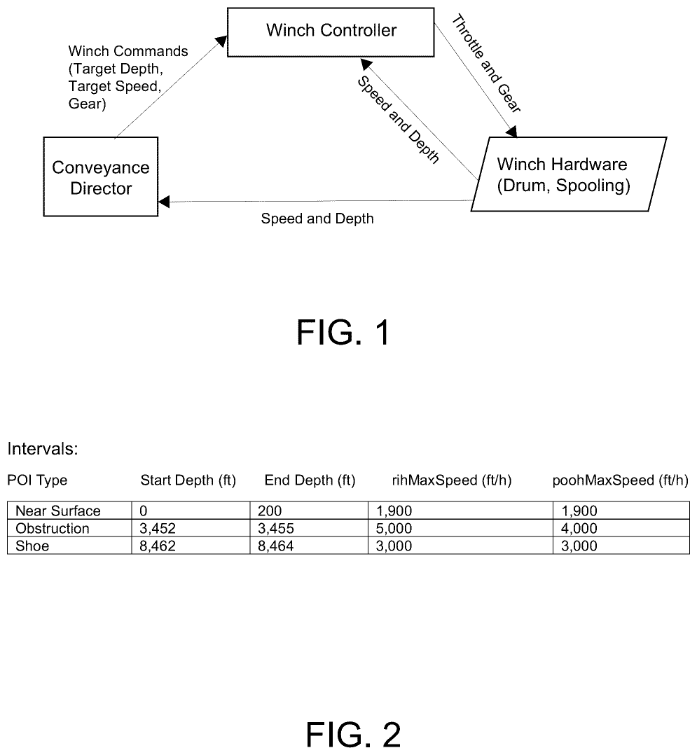

In one embodiment of the aspects described, FIG. 1 discloses an overview of the automation system and data flow, whereby the conveyance director is responsible for higher-level control. The automation system decides the speed the winch should move at and what depth it should move to, which is evaluated twice per second. The frequency of twice per second may be altered, as necessary and the aspects of the disclosure should not be bound by the stated frequency. Restriction navigation decisions are made here. The conveyance director commands the winch controller which depth the conveyance director needs to reach and at which speed, including new speeds based on restrictions.

The winch controller performs low-level winch control. The winch controller is given data related to a target depth, target speed, and winch gear. This data may be input by an operator or may be calculated by a programmable computer. The winch controller runs a control loop to closely control the winch speed, including acceleration and deceleration when changing target speed. The winch controller also runs a control loop to monitor the toolstring depth and to stop the toolstring at the correct target depth. The controller outputs a throttle value and the gear the winch will run at. In embodiments, the controller updates values 10 times per second. Other update rates may be used.

Winch hardware may include, at least in part, the actual drum that is rotating and spooling in/out cable. The winch hardware is driven by throttle and gear values from the winch controller and produces depth and speed measurements used for feedback by the other elements in the system.

### RESTRICTION SPECIFICATION

Prior to a run, restrictions are defined, as shown in FIG. 2, in the DEP enabling the automation system to accommodate them effectively. The DEP introduces restrictions as a high-level job description of wellbore operations which informs the well-logging system's automation controller about operational parameters. This high-level job description delineates restrictions by specifying the top and bottom depths (representing the uphole and downhole limits of the restriction), the maximum permissible speeds for both running in-hole and pulling out of hole procedures, and a point of interest (POI) to categorize the type of the restriction.

### RESTRICTIONS NAVIGATION ALGORITHM

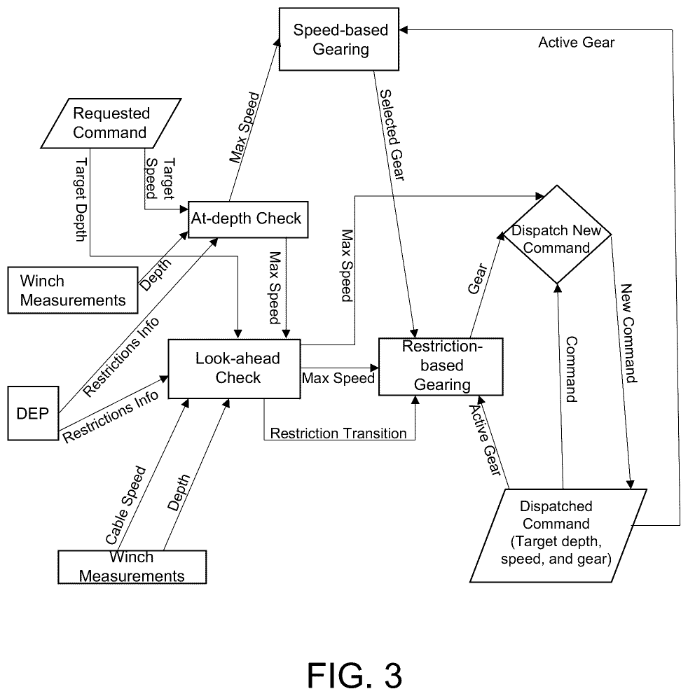

In one embodiment of the disclosure, FIG. 3 presents the steps and data flow for the restriction navigation algorithm of the automation system, where the algorithm is broken down into several steps to ensure that the restriction navigation is run smoothly during wireline or slickline operations, the steps involve are described in detail below.

### INPUTS

The core algorithm is run periodically. The algorithm is given an initial command (the requested command in FIG. 3), which contains a target depth (that is, the depth the toolstring will be conveyed to) and a target speed, which is the intended speed of the toolstring. Not shown is the source of the command, which could be operator input or a fully automated job orchestration system. In embodiments, this command represents the will of the operator. In some embodiments, the commands may not change. In other embodiments, the commands may be altered as necessary.

Other inputs to the algorithm include the DEP and the winch measurements. The DEP contains information about restriction boundaries and speeds. This is a one-time input to the system. Winch measurements include the current depth and speed of the toolstring as it is conveyed. These values are updated many times per second, to provide accurate information.

### FIRST STEP: AT-DEPTH CHECK

In one step of the algorithm, a comparison is made comparing the current depth of the toolstring against the restrictions. If any part of the toolstring intersects with any restriction, the maximum speed output of this check is the minimum value of the requested target speed and the minimum restriction speed in the winch's direction of travel.

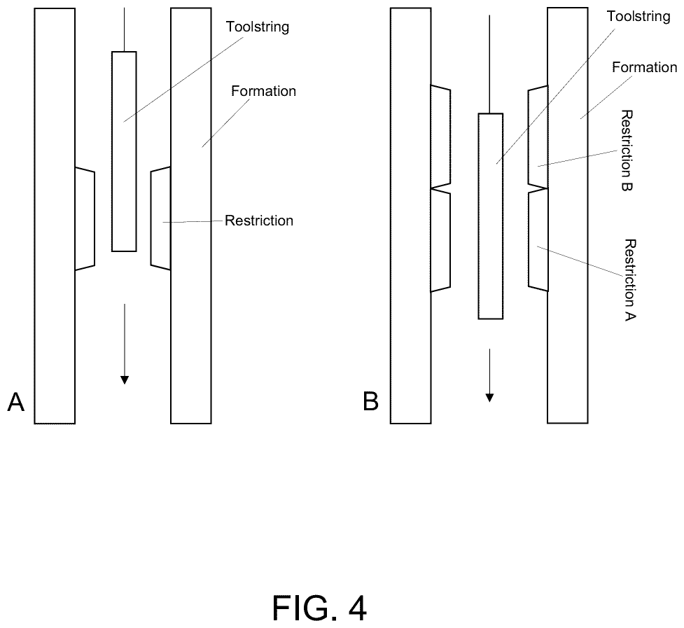

As shown in FIG. 4, in the first wellbore (A), the toolstring is within a single restriction. The speed chosen is the lowest of three speeds: the speed limit in the upper unrestricted section, the speed limit in the restriction, and the speed limit in the lower unrestricted section. While in the second wellbore (B), the toolstring is simultaneously within two different restrictions. In this case, the speed chosen is the lowest of four speeds: the speed limit in the upper unrestricted section, the speed limit in restriction A, the speed limit in restriction B, and the speed limit in the lower unrestricted section.

In non-limiting embodiments, it is important to note that the chosen speed is not yet passed to the hardware, as the required maximum speed may be overridden by subsequent steps. The chosen speed is given as input to the next step in the algorithm, described below.

### SECOND STEP: LOOK-AHEAD CHECK

The second step of the algorithm is to attempt to predict what will happen to the toolstring in the future. Inputs to this step are restrictions information, the maximum speed from the previous step, the current depth and speed, and the target depth from the requested command.

Current depth is compared against the full set of restriction information, and the next restriction transition in the direction of travel is found. Types of transitions include, but are not limited to, moving into a restriction from an unrestricted region, moving out of a restriction into an unrestricted region, or moving from a restriction into an adjacent restriction. Properties of the transition that are relevant are depth of the transition, distance from current depth to the transition, and speed after the transition. If the depth of the transition is farther away than the requested command's target depth, the transition will not be encountered before target depth is reached and the toolstring stops. In this case, the method does not need to check any further; the output of the step is the same maximum speed that was given as input.

Next, the speed after the transition is checked against the maximum speed given as input. If the new speed is greater than or equal to the old speed, the new speed will be applied when the new region is reached (because of the at-depth check step), so no further action is needed. The output value is the same maximum speed given as input.

It is now known that the transition will be encountered, and that the toolstring will need to slow down before reaching the transition. In embodiments, the toolstring must not slow down prematurely. The acceleration rate applied to the toolstring by the winch controller is a known parameter (not shown in the diagram). Accordingly, a calculation is performed to find the distance required to slow down to the new speed, based on the current speed and the new speed. If the distance to the transition is greater than the slowdown distance, there is no action to be taken yet, so the output value is the same maximum speed given as input.

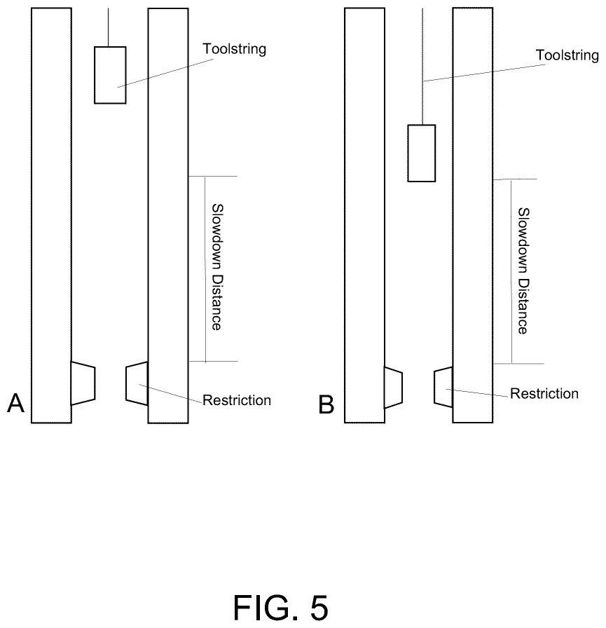

Once the distance to the transition is less than or equal to the slowdown distance, the toolstring needs to begin slowing down to encounter the transition at the correct speed. Accordingly, the maximum speed is assigned to be the same as the future post-transition speed limit. By telling the winch controller early to go to a reduced speed, the winch controller will slow down the toolstring at a known acceleration, such that the toolstring reaches the new speed concurrently with encountering the transition into a restriction. Information about the transition causing the new speed is also output to feed into subsequent steps. FIG. 5 demonstrates scenarios related to slowdown distance.

As illustrated in FIG. 5, in the first wellbore (A), the toolstring is moving downward but has not yet reached the distance that it would take to slow down for the restriction. Accordingly, the look-ahead algorithm will not adjust the speed. While in the second wellbore (B), the toolstring has reached the depth corresponding to how long it will take the toolstring to decelerate to the speed for the restriction. The look-ahead algorithm gives a speed corresponding to the speed of the upcoming restriction. The winch controller will slow the toolstring in accordance with this new speed, and the toolstring will be at the correct speed for the restriction once the leading edge of the tool reaches the restriction.

Similar to that of the first step (at-depth check), the maximum speed is not yet passed to the hardware, even though the required maximum speed is now known. Subsequent steps are needed to discover other hardware parameters, such as gearing, which must all be given to the hardware together.

### THIRD STEP: SPEED-BASED GEARING

The third step of the algorithm takes the speed output from the previous step and determines what the appropriate gear is based on that speed. It is a simple mapping of specific speed ranges to gears, based on the capabilities of the underlying hardware. It also takes the currently active gear into account, in order to avoid switching gears unnecessarily. The output of this step is the appropriate gear based solely on the maximum speed as given by the previous steps.

### FOURTH STEP: RESTRICTION-BASED GEARING

The fourth step takes restrictions into account to determine gearing. The objective is to mimic a human operator's ability to navigate a restriction at a speed that is normally too high for that gear, to avoid stopping the winch for a gear change. This step takes as input the speed-based gear from the previous step, the currently active gear, the speed that has been determined from previous steps, and information about the transition that caused a speed decrease due to upcoming restrictions (if one exists). If the speed-based gear matches the current gear, there is no need to act. The same gear given as input is also the output. The transition information is also checked. If there is no transition into a restriction, then either the same gear will apply or a higher gear will be selected. The speed-based gear given as input, therefore, is provided as the output.

Next, a minimum speed check is applied. If the intended speed is too low, the winch hardware will be unable to drive the winch in a higher gear. In this case, the speed-based gear selection must be used, so the gear selected is output. Similar to above, the transition information is checked again. Certain restrictions have properties that disallow holding a high gear. If a restriction is too close to the surface and a low gear is warranted based on speed, that gear must be used. A restriction that is too long should result in the speed-based gear being used, as the inability to reliably control the winch speed for a significant duration at an incorrect gear for that speed outweighs the efficiency gains from not stopping to change gears. The speed-based gear is output.

Lastly, the speed-based gear is compared against the currently active gear. If the speed-based gear is a higher gear than the active gear, the gear change is allowed, and the output is the speed-based gear. If the speed-based gear is a lower gear than the active gear, the active gear is chosen to remain the appropriate gear; and the output from the step is the currently active gear.

### DISPATCH NEW COMMAND

The previously described steps have created speed and gear values that may not match the command that was originally requested. If this is so, and the new command is different from the previously dispatched command, the new command is dispatched to the winch controller, containing the same target depth as the requested command, but with the new speed and gear.

### EXAMPLES

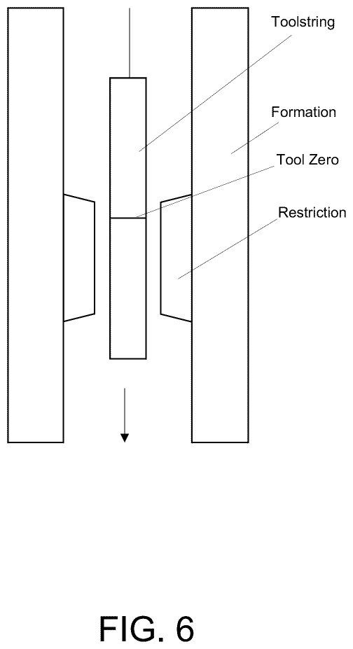

FIG. 6 demonstrates an example of gaps in the current automation system, and how the automation system described is able to solve the issues.

As seen in FIG. 6, if the system waits until current depth at tool zero is at the top of the restriction, the bottom of the toolstring is already in the restriction and moving too fast. If the system accelerates the tool back up to normal speed as the tool zero passes the restriction, the top of the toolstring will still be in the restriction as the toolstring accelerates faster than restriction speed. The same happens in reverse if conveyance direction is upward.

Additionally, if the restriction speed limit is significantly slower than normal speed, the toolstring may come to a stop to switch to a lower gear, then stop again to switch to back to a higher gear when leaving the restriction. Experienced manual operators may not switch gears in this situation, which means that existing automation causes an unnecessary time loss.

As described above, the automation system of the present disclosure is able to solve the above issues by:
using awareness of toolstring length to guarantee that the restriction speed limit is obeyed whenever any part of the toolstring is within the restriction,
predicting future restrictions in the direction of conveyance to decelerate to an appropriate speed prior to entering a restriction, and
maintaining a higher gear at low speeds, when possible, to avoid lost time due to gear changes.

Variations of the described arrangements and methods are contemplated. In some embodiments, control of the descending toolstring may occur under a manual or a manual assist mode. To achieve operational efficiency, in some embodiments, automated control may be altered or temporarily suspended. For example, a set threshold may be created such that when, in a case of a descending toolstring approaching a restriction, an alteration of the descent may be achieved. This alteration may include switching into a low speed mode or switching into a manual control mode. In one example embodiment, the threshold may be established by an on-site engineer. An example threshold may be, for example, 100 feet distance between the bottom of the tool string and the restriction. Other values may be chosen. In some embodiments, a visual alarm may be provided to the operator that a restriction is set to be encountered or that a restriction may be passed. In some alternative embodiments, speed may be automatically declared through restrictions. These automatic declarations may be established through field experience such that exceeding some speed values may be cause for impact or other deleterious conditions. To prevent such conditions from occurring, but to maintain maximum efficiency during tool transitions, a speed limit may be established. As will be understood, such speed restrictions may be based on local conditions, wellbore parameters, safety conditions or other parameters.

Visual identification of the position of the toolstring may be provided to allow operators the ability to see if the toolstring is encountering the restriction. Once the restriction is passed, an operator may choose for the operations to continue in an autonomous mode, if desired.

Embodiments of the claims are described next. The description of the embodiments of the claims should not be considered limiting of the disclosure. In one example embodiment, a method for autonomous restriction navigation of a toolstring in a downhole environment is disclosed. The method may comprise defining at least one restriction specification in a digital execution program. The method may also comprise inputting the digital execution program into a core algorithm. The method may also comprise comparing a current depth of the toolstring against the at least one restriction specification. The method may also comprise predicting a future action of the toolstring. The method may also comprise determining at least one appropriate gear based on the future action of the toolstring. The method may also comprise comparing the at least one appropriate gear with another one or more appropriate gears to determine an output.

In another example embodiment, the method may be performed wherein the future action of the toolstring is predicted by inputting restriction information, maximum a speed from the comparing the current depth of the toolstring against the at least one restriction specification, current depth and speed, and target depth from a requested command.

In another example embodiment, the method may be performed wherein the at least one appropriate gear is a speed-based gear or an active gear.

In another example embodiment, the method may be performed wherein the output is a speed-based gear or an active gear.

In another example embodiment, a system for autonomous restriction navigation is disclosed. The system may comprise a processor and a memory accessible to the processor. The system may further comprise processor-executable instructions stored in the memory and executable by the processor to instruct the system to define one or more restriction specifications in a digital execution program. The instructions may also comprise inputting the digital execution program into a core algorithm. The instructions may also be configured to compare a current depth of a toolstring against the at least one restriction specification. The instructions may also be configured to predict a future action of the toolstring. The instructions may also be configured to determine one or more appropriate gears based on the future action of the toolstring and compare the one or more appropriate gears with another at least one appropriate gear to determine an output.

In another example embodiment, the system may be configured wherein the future action of the toolstring is predicted by inputting restrictions information, a maximum speed from the comparing the current depth of the toolstring against the at least one restriction specification, current depth and speed, and target depth from a requested command.

In another example embodiment, the system may be configured wherein the at least one appropriate gear is a speed-based gear and an active gear.

In another example embodiment, the system may be configured wherein the output is at least one of a speed-based gear and an active gear.

In another example embodiment, a method for autonomous restriction navigation of a toolstring in a downhole environment is disclosed. The method may comprise defining at least one restriction specification in a digital execution program. The method may further comprise inputting the digital execution program into a core algorithm. The method may further comprise comparing a current depth of the toolstring against the at least one restriction specification. The method may further comprise predicting a future action of the toolstring. The method may further comprise determining at least one appropriate gear based on the future action of the toolstring. The method may further comprise comparing the at least one appropriate gear with another at least one appropriate gear to determine an output. The method may further comprise operating a winch according to the output.

In another example embodiment, the method may be performed wherein the operating the winch according to the output includes switching to a manual winch operation mode when a threshold is reached.

In another example embodiment, the method may be performed wherein the threshold is established through one of an operator input and the digital execution program.

In another example embodiment, the method may be performed wherein a visual representation of the toolstring in relation to the restriction specification is presented to the operator during the operating of the winch.

In another example embodiment, the method may further comprise operating the winch in an automated mode after all restrictions in the specification are passed.

In another example embodiment, the method may be performed wherein the operating the winch in the automated mode is performed with regard to a speed limit.

In another example embodiment, the method may be performed wherein the speed limit is established through one of a database based on a wellbore construction and geological features.

In another example embodiment, the method may further comprise providing a warning to an operator when a restriction within the restriction specification is reached.

In another example embodiment, the method may further comprise removing the warning to the operator when the restriction within the restriction specification is cleared.

In another example embodiment, the method may be performed wherein the operator is located remotely from the winch.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for autonomous restriction navigation of a toolstring in a downhole environment comprising:
defining at least one restriction specification in a digital execution program;
inputting the digital execution program into a core algorithm;
comparing a current depth of the toolstring against the at least one restriction specification;
predicting a future action of the toolstring;
determining at least one appropriate gear based on the future action of the toolstring; and
comparing the at least one appropriate gear with another one or more appropriate gears to determine an output.

2. The method according to claim 1, wherein the future action of the toolstring is predicted by inputting restriction information, maximum a speed from the comparing the current depth of the toolstring against the at least one restriction specification, current depth and speed, and target depth from a requested command.

3. The method according to claim 1, wherein the at least one appropriate gear is a speed-based gear or an active gear.

4. The method according to claim 1, wherein the output is a speed-based gear or an active gear.

5. The method according to claim 1, further comprising operating a winch according to the output.

6. The method according to claim 5, wherein the operating the winch according to the output includes switching to a manual winch operation mode when a threshold is reached.

7. A system for autonomous restriction navigation comprising, the system comprising:
a processor;
memory accessible to the processor;
processor-executable instructions stored in the memory and executable by the processor to instruct the system to:
define one or more restriction specifications in a digital execution program;
input the digital execution program into a core algorithm;
compare a current depth of a toolstring against the at least one restriction specification;
predict a future action of the toolstring;
determine one or more appropriate gears based on the future action of the toolstring; and
compare the one or more appropriate gears with another at least one appropriate gear to determine an output.

8. The system according to claim 7, wherein the future action of the toolstring is predicted by inputting restrictions information, a maximum speed from the comparing the current depth of the toolstring against the at least one restriction specification, current depth and speed, and target depth from a requested command.

9. The system of claim 7, wherein the at least one appropriate gear is a speed-based gear and an active gear.

10. The system of claim 7, wherein the output is at least one of a speed-based gear and an active gear.

11. A method for autonomous restriction navigation of a toolstring in a downhole environment comprising:
defining at least one restriction specification in a digital execution program;
inputting the digital execution program into a core algorithm;
comparing a current depth of the toolstring against the at least one restriction specification;
predicting a future action of the toolstring;
determining at least one appropriate gear based on the future action of the toolstring;
comparing the at least one appropriate gear with another at least one appropriate gear to determine an output; and
operating a winch according to the output.

12. The method according to claim 11, wherein the operating the winch according to the output includes switching to a manual winch operation mode when a threshold is reached.

13. The method according to claim 11, wherein the threshold is established through one of an operator input and the digital execution program.

14. The method according to claim 11, wherein a visual representation of the toolstring in relation to the restriction specification is presented to the operator during the operating of the winch.

15. The method according to claim 11, further comprising operating the winch in an automated mode after all restrictions in the specification are passed.

16. The method according to claim 11, wherein the operating the winch in the automated mode is performed with regard to a speed limit.

17. The method according to claim 16, wherein the speed limit is established through one of a database based on a wellbore construction and geological features.

18. The method according to claim 11, further comprising providing a warning to an operator when a restriction within the restriction specification is reached.

19. The method according to claim 18, further comprising removing the warning to the operator when the restriction within the restriction specification is cleared.

20. The method according to claim 19, wherein the operator is located remotely from the winch.
